(19) United States
(12) Patent Application Publication
(10) Pub. No.: US 2004/0070692 A1
(43) Pub. Date: Apr. 15, 2004

(54) Video enhancement component

(76) Inventor: H. George Pires, Borough of Hampton, NJ (US)

Correspondence Address: Kenneth P. Glynn, Esq., Glynn & Associates, P.C., 24 Mine Street, Flemington, NJ, 08822, US

(21) Appl. No.: 10/271,071

(22) Filed: Oct. 15, 2002

(51) Int. Cl. H04N 5/21

(52) U.S. Cl. 348/625

(57) ABSTRACT

A system for enhancing the clarity of video images by changing the pulse response characteristics. A correcting signal that is proportional to the slope of the rise time is generated, processed and then added to the original signal. The combined signal is then monitored with a device that has the ability to check for the presence of overshoots on fast rise time high amplitude signals. When such overshoots are detected, the system switches to a component of the signal which has no overshoot for the duration in time that the overshoot exists, thereby greatly diminishing or eliminating the overshoots.

### BACKGROUND OF THE INVENTION

1. Field of the Invention

The present invention relates to video enhancement components, and especially digital video enhancement components, that may be deployed in video presentation systems to provide a more crisp, clearer presentation for a given set of video signals.

2. Information Disclosure Statement

There are different formats in which video signals are generated and processed. In a color signal, the basic originating format is usually three channels, red, green and blue. In high-resolution systems, this format is retained up to the display monitor that also operates in that format. In monochrome systems there is only the luminance channel. Generally, color signals, although generated in red, green and blue, are converted right at the originating point to a luminance and two color components, before leaving the originating device, by a process known as encoding to form a luminance component and two additional color components. There are several forms in which the color components are encoded, but the luminance component essentially is the same for almost all color encoding. The luminance component is derived from a portion of the red, green and blue channels using a formula, the details of which are outside the scope of this discussion. It is sufficient to mention that after the encoding process, the luminance component thus derived is equivalent to a signal that would have been generated if it had been a monochrome system. The luminance component is the one that establishes the sharpness of the image. Systems which have higher bandwidth luminance channels appear to be more sharply in focus than lower bandwidth systems. Improving the rise times of the transitions of the luminance channel makes the picture look sharper even if nothing else is done to the color channels. One object of the present invention is to improve the quality of the luminance signal, thus making the visual image appear much more sharply in focus. Alternatively, in a system which uses three channels of red, green and blue throughout, the present invention may be applied individually to all three channels, and will then have the same effect as when it is done for a luminance channel alone.

The industry has generally tried to improve the rise times of transitions in the luminance channel in several ways, the most common being by boosting the high frequency components to a larger extent than low frequency components in the signal. This technique causes complications which are apparent when the pulse or transient response is examined. Boosting of high frequencies relative to low frequency components causes pulses to have overshoots. The visual effect on an image having a poor transient response caused by this particular method for enhancement, is that when there are flat areas such as a white box over a darker background, a white line appears on the left edge of the box, and a black line appears on the right edge of the box.

Other approaches have been taken where large amplitude and small amplitude changes are treated differently, but these use discrete components and cannot readily be implemented into MOS chips. When these circuits are modified to enable insertion into MOS chips, they suffer other problems such as the inability to process several closely spaced transitions. These systems are also analog in nature and cannot be implemented into large digital chips.

An objective of the present invention is to operate entirely in the digital format and to be capable of being incorporated into larger chips where the signal is already in the digital domain. In the larger chips, if the signal is in the form of three channels, red, green and blue, this invention may be incorporated into each of the three channels, thus producing the same result as if it was implemented in a single luminance channel, added to which will be an improvement in color response.

Notwithstanding the prior art, the present invention is neither taught nor rendered obvious thereby.

### SUMMARY OF THE INVENTION

The present invention is a video enhancement component for enhancing a video signal. It includes a slope detector means for generating a slope detected signal, the amplitude of which is dependent on the change in amplitude of an input video signal. This may be a slope detector means that generates one or both of a negative slope detected signal and a positive slope detected signal. It also includes means for setting a first threshold level, being a high threshold level, for the slope detected signal, and means for setting a second threshold level, being a low threshold level, for the slope detected signal. There is also a threshold change switching means connected to the first and second threshold setting means. In the case of the preferred embodiments wherein the slope detector means generates both positive and negative slope detected signals, two sets of threshold setting means are used, one set for negative, and one set for positive signals.

There is also one slope comparator means for comparing the slope detected signal with said threshold change switching means, and two such comparators when both positive and negative slope detected signals are generated. There is a slope change switching means to switch between the slope detected signal and a lower level signal to generate a second signal, and means for combining the second signal from the slope change switching means with the input video signal to create an enhanced signal to generate sharper images.

In preferred embodiments wherein the slope detector means includes means to generate both positive slope detected signals and negative slope detected signals, the present invention video enhancement component includes a first subsystem for positive slope detected signals, which includes:

means for setting a first threshold level of the positive slope detected signal;

means for setting a second lower threshold level of the positive slope detected signal;

threshold change switching means connected to the first and the second threshold setting means;

positive slope comparator means for comparing the positive slope detected signal with the threshold change switch means;

slope change switching means to switch between the positive slope detected signal and a lower level signal to generate a second signal; and,

means for combining the second signal from the positive slope change switching means with the input video signal; and,

the present invention video enhancement component further includes a second subsystem for negative slope detected signals, which includes:

means for setting a first threshold level of the negative slope detected signal;

means for setting a second threshold level of the negative slope detected signal;

threshold change switching means connected to the first and the second threshold setting means;

negative slope comparator means for comparing the negative slope detected signal with the threshold change switch means;

slope change switching means to switch between the negative slope detected signal and a les negative level signal to generate a second signal; and,

means for combining the second signal from the slope change switching means with the input video signal.

In some preferred embodiments, the present invention component further includes an analog to digital converter upstream from the slope detector means, and further includes a digital to analog converter downstream from the means for combining the second signal with the input video signal.

Also, preferred embodiments of the present invention component further include a low pass filter interposed between the second signal and the means for combining the second signal with the input video signal. Likewise, means for amplifying the output of the slope detector means, is preferred.

In some preferred embodiments, the component of the present invention slope detector means includes a subtracting element means, a means for delaying an original input video signal to create a delayed input video signal, connecting means for inserting the original input video signal into a first input of the subtracting element means, and connecting means for inserting the delayed input video signal into a second input of the subtracting means. Thus, for example, the present invention component slope detector means may include means for creating a plurality of separately delayed input video signals, and subtracting means connected to two of the plurality of delayed input video signals to generate the slope detected signal and wherein the means for combining the second signal with the input video signal combines the second signal with one of the plurality of delayed input video signals. There may also be a gain controlling means interposed between the slope detector means and the means for combining the second signal and the input video signals.

In other embodiments of the present invention, the video enhancement component for enhancing a video signal of the present invention may include an overshoot comparator means for comparing the combined second video signal and the original input video signal to create an activated output; output control switch means for switching between the combined video signal and the original input video signal, and; controlling means to activate the output control switch means only when the slope comparator and the overshoot comparator are activated.

In yet other preferred embodiments, the present invention component for enhancing a video signal includes a delay means for creating a delayed video signal, a slope detector means for generating a slope detected signal from the delayed video signal, means for setting a first threshold level, means for setting a second lower threshold level, first switching means connected to first and second threshold setting means, slope comparator means for comparing the slope detected signal with the first switch means to create an activated output, second switching means to switch between said slope detected signal and a constant low level signal, means for combining the signal from the second switching means with the originating video signal to form a combined video signal, overshoot comparator means for comparing the combined video signal and the undelayed video signal to create an activated output, third switch means for switching between the combined video signal and the undelayed video signal and controlling means to activate the third switch means only when first and second comparators are activated.

### BRIEF DESCRIPTION OF THE DRAWINGS

The present invention should be more fully understood when the specification herein is taken in conjunction with the drawings appended hereto wherein:

FIG. 1 illustrates a block diagram of a preferred present invention embodiment with analog to digital and digital to analog converters;

FIG. 2 shows a graphic illustration of a signal representing a single horizontal line of a luminance channel for color or the complete signal for monochrome;

FIG. 3 shows a horizontally expanded version of the active video portion of the graphic illustrations of FIG. 2;

FIG. 4 illustrates a small amplitude transition before and after pulse reshaping and overshoot removal;

FIGS. 5(a) through 5(f) show a series of waveforms in an analog formal;

FIGS. 6(a) and 6(b) and 7(a) and 7(b) illustrates various waveforms outputs and the incremental differences in amplitude between each waveform, respectively; and,

FIG. 8 illustrates an original small amplitude fast rise timer signal with a reshaped signal with an overshoot.

### DETAILED DESCRIPTION OF THE PRESENT INVENTION

One of the objects of this invention to improve the quality of video signals by making them appear to be more sharply in focus without the artifacts which are conventionally introduced by other methods. The primary artifact being eliminated or substantially reduced is overshoots on large transitions.

It is a further object of this invention to raise the amplitude of small transitions by increasing the rise time and also by introducing overshoots, because the latter enhances the quality of the signal. Even though adding overshoots to small transitions are actually artifacts, they are benign ones making items such as fine lines or hair, stand out sharply. The reason why small transitions do not benefit from simply improving their rise time is that since they are small to start with, the incremental improvement in rise time has no visual impact on the eye. It is yet a further object of this invention to operate in a digital domain and it can therefore be easily implemented in digital CMOS chips. It is yet a further object of this invention to be capable of being implemented into larger chips, which are already operating in the digital domain.

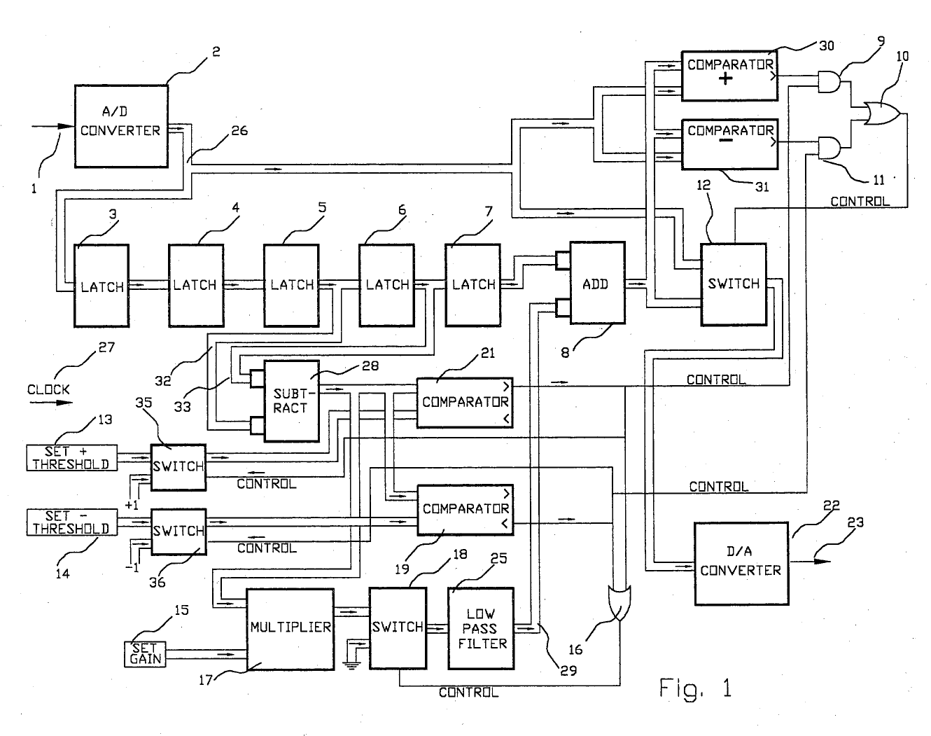

Another object of this invention is the different processing of positive and negative transitions along different channels. Though for the purpose of explanation in this description, equal amplitudes are generally discussed, this invention allows the positive and negative clipping thresholds to be set differently allowing, for some applications, negative transitions to be treated differently from positive transitions. FIG. 1 is a block diagram of a system which has an analog to digital converter (ADC), which converts an analog luminance video signal into a digital signal, processing circuitry which culminates in a digital to analog converter (DAC). The macro functions of the blocks in between the ADC and the DAC will be explained in the detailed description to follow. For the sake of clarity each block in FIG. 1 represents an overall macro function defined by its name. For instance the Multiplier 17 uses circuits well accepted and known to those conversant with the art of multiplying two digital numbers. The same applies to comparators, low pass filter, ADC, etc.

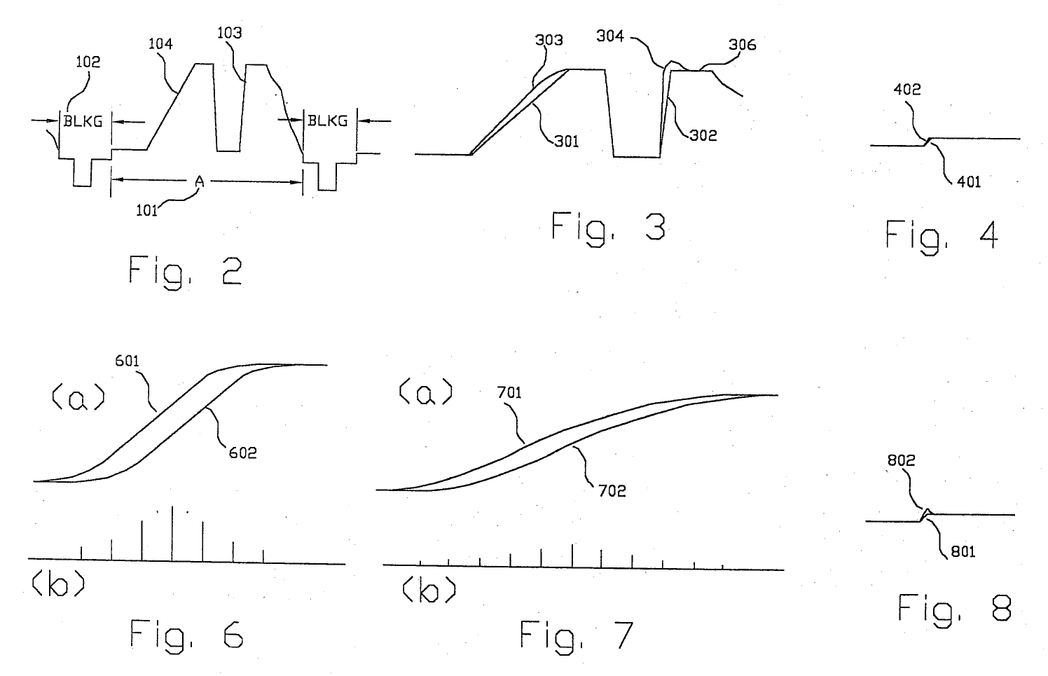

FIG. 2 depicts a single horizontal line of the luminance channel of a video signal if the signal is color or the complete signal if it is monochrome. The two primary portions of the signal are identified as the blanking interval and the rest of the signal which constitutes the active portion of the video signal.

FIG. 3 depicts a horizontally expanded version of the active video portion of the line in FIG. 2. Waveform 301 is a slow transition while waveform 302 is a faster one. Curves 303 and 304 in the diagram show the signal after it has been processed through a peaking circuit. Curve 303 derived from the slower waveform 301 shows an improvement in rise time with no overshoot. However curve 304, which is derived from the faster waveform 302, has an overshoot.

FIG. 4 depicts a small amplitude transition before and after pulse reshaping and overshoot removal. Waveform 401 depicts a small fast transition and waveform 402 depicts the same waveform with a faster rise time and no overshoot. It will be noticed that there is a very small difference and it escapes notice by the eye when the image represented by these waveforms is displayed on a picture monitor.

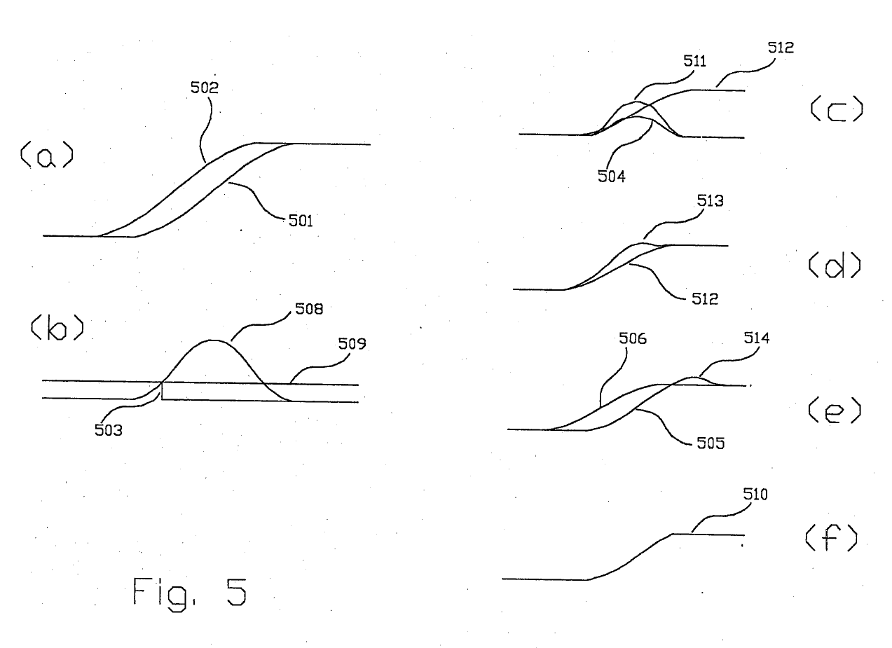

FIG. 5 shows a series of waveforms in an analog format, even though they are actually digital waveforms which have instantaneous values that change with each incremental clock pulses. Showing the waveforms in an analog fashion makes it easier to explain and understand the theory of operation. The drawings are not to scale, in order to accentuate the subject matter.

FIG. 5(a) shows Waveform 502, the output of Latch 5 in FIG. 1 and Waveform 501, the output of Latch 6 in FIG. 1.

FIG. 5(b) shows Waveform 503, the output of Switch 18 in FIG. 1 and Waveform 508, the output of Subtracting Element 28. The threshold level set by 13 is indicated by 509.

FIG. 5(c) shows Waveform 504, the signal on Bus 29 when the Multiplier gain is set to a level to cause no overshoot at the output of Adder 8. Waveform 511 is the signal on Bus 29 when the Multiplier gain is set to a level to create a small overshoot at the output of Adder 8. Waveform 512 is the output of Latch 7.

FIG. 5(d) shows Waveform 513, the output of Adder 8 when 504 is added to 512; and, FIG. 5(e) shows Waveform 506, the waveform on Bus 26. Waveform 505 is the output of Adder 8 when 511 is added to 512. Segment 514 is the overshoot of Waveform 505.

FIG. 5(f) shows Waveform 510, the output of Switch 12.

FIG. 6(a) shows Waveform 601, the output of Latch 5 for a fast rise time pulse. Waveform 602 is the output of Latch 6 for the same pulse delayed by one clock pulse.

FIG. 6(b) shows Waveform 603, which shows the instantaneous difference in amplitude between waveforms 601 and 602. A smooth curve drawn on and connecting the peaks would represent the analog equivalent of the differences.

FIG. 7(a) shows Waveform 701, the output of Latch 5 for a slow rise time pulse. Waveform 702 is the output of Latch 5 for the same pulse delayed by one clock pulse; and, FIG. 7(b) shows Waveform 703, the instantaneous difference in amplitude between waveforms 701 and 702. A smooth curve drawn on and connecting the peaks would represent the analog equivalent of the differences.

FIG. 8 depicts the original small amplitude fast rise time signal, 801, together with the reshaped signal with an overshoot. It will be noticed that there is a considerable change in the transition and when the image represented by this signal is viewed on the monitor, the difference is immediately apparent; the edge becoming far more pronounced. The overshoot makes itself evident as a pleasantly sharp edge instead of an unpleasant artifact.

Description of the Theory of Operation:

FIG. 2 shows one horizontal line of a video signal in time domain. There are two basic components. One component is the blanking interval 102, and the rest of the signal constitutes the portion of the signal which carries the actual video information. Segment 103 is a portion of that waveform which represents a relatively fast rising edge. Segment 104 is a slow rising edge. FIG. 3 is a horizontally expanded view of interval A in FIG. 2. It shows two positive transitions 301 and 302. These two transitions 301 and 302 show the edges of transitions from black to white. Transition 301 is slower than transition 302. On the television monitor, the edge depicted by transition 301 will appear soft or fuzzy compared with the edge depicted by transition 302. There are techniques for sharpening the edge, or making the rise time faster. A common way to increase the sharpness of transition is to put the signal through a peaking circuit, which has a higher gain at high frequencies compared to low frequencies. When a limited amount of peaking is applied, the result is shown by the curves 303 and 304 in FIG. 3. The rise time of curve 303 is faster than the rise time of curve 304 but there is no overshoot. The lack of overshoot is simply because the amount of peaking introduced is relatively low in comparision to the rise time. However the same amount of peaking causes an overshoot on the faster waveform as shown by curve 304. When this signal is displayed on a monitor, the overshoot will appear as a spurious and objectionable white line on the edge between the dark area 305 and the white area 306. This demonstrates the effect of a certain limited amount of peaking. Very slow transitions are improved; fast transitions are degraded with an overshoot.

Waveform 401 in FIG. 4 shows a relatively fast small black to white transition. Waveform 402 shows the result if that waveform was put through a hypothetical circuit which could improve the rise time without adding an overshoot. Because the signal is so small the difference is almost unnoticeable in the waveform. It is equally unnoticeable when that waveform is displayed on a monitor.

Waveform 801 in FIG. 8 is the same waveform as that depicted as waveform 401 in FIG. 4. Waveform 802 is the result of processing waveform 801 through a hypothetical circuit which both increases the rise time and adds an overshoot. The edge represented by the overshoot is far more noticeable on the diagram. When the signal depicted by this waveform is displayed on a television monitor, the edge represented by the overshoot stands out far more clearly than waveform 402. It also appears pleasing and gives the appearance of merely being “crisp” or more sharply focused.

Detailed Description of the System:

For the sake of clarity, FIGS. 5, 6 and 7 are shown as smooth analog waveforms. In reality they are instantaneous values changing with each clock pulse and which could be represented by vertical lines. However, the principles and description set forth in this disclosure would be difficult to comprehend with that kind of representation. The smooth waveforms here are actually formed by the top tips of those lines with smooth interpolations in between.

An analog video signal, represented by FIG. 2 is inserted into the Analog to Digital Converter, 2, generally described as an ADC or A/D Converter. These are readily available chips operating with eight, ten or higher number of bits. For the purpose of this description, it will be assumed to have eight bits. The double line grouping such as 26 represents eight bit buses. A bus in this instance is a group of eight lines, each carrying one bit of the eight bit signal. All the blocks shown in this figure denote devices which have eight members performing the same operation, each member performing it on one of the eight bits. For instance the Latch, 3 is actually eight D flip-flops, or latches, all clocked by the same clock line, and each latch accepting one bit of the eight bit input bus as an input, and outputting one bit on the output bus. The same concept applies to each of the other blocks, such as the comparators, switches, multiplier etc.

The system clock, 27, is connected to all the latches 3, 4, 5, 6 and 7, the adder 8, the subtracting element 28, the four comparators 19, 21, 30 and 31, and the Digital to Analog Converter (DAC or D/A Converter) 22 and to the Analog to Digital Converter and the low pass filter. The connections are not shown in the diagram for the sake of clarity. The clock frequency may be selected over a wide range to accommodate different television standards. For this description it will be assumed to be approximately 70 nanoseconds (ns).

Latches 3, 4, 5, 6 and 7 form a delay line. The output of each latch is the exact time shifted replicas of the original video signal, each delayed in time by the period of one clock pulse.

The outputs of latches 5, and 6, in combination with the subtracting element 28 constitute an edge detector or slope detector, the amplitude of the output of which is a slope detected signal whose output is dependant on the slope and amplitude of the rise time of the video signal, as clarified in FIG. 6. Waveform 603 is defines the instantaneous difference between the waveforms 601 and 602. The pulses in waveform 603 are largest where the slope of the incoming waveform is greatest and zero where there is no change in amplitude in the signal.

The output of Subtracting element 28 is fed to a First Comparator 21, which has two outputs one is “greater than”, denoted by “>” and the other is “less than” denoted by “<”. The other input to this comparator is connected to the Switch 35, which in turn also has two inputs one of which is the threshold setting device 13 and the other is low level such as +1. The +Threshold setting device established the threshold above which the circuit defines the signal to be a large amplitude transitions and below which it is considered to be a low amplitude signal.

When the signal at the output of subtracting element 28 exceeds the threshold level set by 13, then the output of Comparator 21 provides a positive output by going high and makes the switch 35 output a signal equal to +1 into the comparator 21. This second input to switch 35 is shown to be +1, for the sake of clarity, but it could be any other small number without materially affecting the operation of the system. Changing the threshold input of Comparator 21 to +1, or other small number, causes no change in the output of Comparator 21. When waveform 508 drops to the lower number set by Switch 35, the control line into Switch 35 goes low again, the threshold gets reset to the +Threshold level set by device 13, and the circuit is ready to respond to the next positive transition. The output of subtracting element 28 also goes to a multiplier 17 and through it to switch 18. The output of the subtracting element 28 is fed as one multiplicand into the multiplier 17. The second multiplicand to that multiplier is set by the “set gain” element 15. If element 15 is set to the number 4, the multiplier 17 would be multiplying all the signals out of the subtracting element 28 by a factor of 4. The multiplier behaves as a gain controllable amplifier. The output of this multiplier is transmitted through a switch 18, the purpose of which is to make the output zero, or other low value, when certain predetermined conditions are met. The second input to the switch 18 is set to zero, or some other low value.

Even though the Comparator 21 responded to the threshold level set by device 13, the signal at the input of the Multiplier 17 and the input to Switch 18 emanating from the Multiplier 17 has been unaffected by the fact that the signal from 28 exceeded the threshold. The signal from the Comparator 21 goes to the switch 18 via the OR Gate 16, and when that control line goes high, Switch 18 outputs a constant level, which is either zero, or a similar constant low level. The output of Switch 18 is the enhancing signal. The amplitude of the enhancing signal follows the changes of the slope detected signal until Switch 18 is activated after which its amplitude drops to a low level, or zero until Switch 18 is deactivated again. The enhancing signal is fed to the Low Pass Filter 25. The output of Switch 18 is shown in waveform 503. The output of the gate 18 is fed into a low pass digital filter 25 which may embody any of the standard digital techniques for selectively attenuating high frequencies in preference to lower frequency components. The purpose of the filter 25 is to roll off or smoothen the output of the switch 18. Waveform 504 is the output of the Low Pass Filter 25, which is represented by Bus 29. When Bus 29 is added to the output of Latch 7, the result at the output of Adder 8, is Waveform 513 which has a faster rise time than the original signal depicted by Waveform 501 and a very small overshoot and constitutes a combined video signal. Since with small amplitude transitions in the original video signal, the slope detected signal never reaches the threshold level at device 13, and therefore the limiting action of do not take place and these low level signals go without attenuation to the Adder 8. Even though these signals are intrinsically small they are proportionately large compared to the originating transitions and produce significant beneficial overshoots as depicted in FIG. 8. To summarize, large amplitude transition have faster rise times with minimal overshoot and small amplitude transitions have a beneficial overshoot. The signal at the output of Adder 8, is already significantly enhanced and could have been used as the final output.

Further improvement in rise time can be made by the following additional circuitry. If the Multiplier's gain is increased a little more, the resultant signal at the output of the Adder 8 will be Waveform 505 in FIG. 5(e). This transition has a faster rise time than waveform 513 but an overshoot 514. Comparator 30 compares Bus 26 which is shown as Waveform 506, with the output of Adder 8 which is represented by Waveform 505. Waveform 505 is the output of Adder 8 obtained by adding Waveform 511 to Waveform 512. When Waveform 505 is higher in amplitude with Waveform 506, the output of Second Comparator 30 furnishes a positive output by going high and through Gate 9 and Gate 10, causes the Switch 12 to change state and switch to Bus 26. The signal on Bus 26 is depicted by Waveform 506. The output of switch 12 is shown in FIG. 5(f) as Waveform 510. This waveform has a sharper rise time than Waveform 513, and has the overshoot 514 clipped off.

Comparator 21 controls the output of Comparator 30 by means of Gate 9. Since Comparator 21 only becomes active on large transitions, Comparator 30 does not operate on small transitions, leaving them to go through unchanged which is one of the objectives of this system. Similarly Comparators 19 and 21 only become active when the transitions exceed the level of the preset thresholds, permitting small transitions to have overshoots.

The operation of the system with positive going transitions has been described above.

The same process occurs in reverse with negative going transitions. These transitions are handled by Comparators 19 and 31.

The output of Switch 12 is fed to the DAC 22, which converts it into an analog signal.

This system can be installed in large digital chips where the signal is already in the digital domain. In such instances, the ADC and DAC are not necessary.

The gain of the Multiplier 17, may be made adjustable and left under the control of the user who will be able to optimize the operation of the system to suit individual requirements.

Video signals cover a wide range of frequencies and bandwidths. High definition television signals have much faster rise times than conventional broadcast television. A system that is optimized for and produces remarkable improvement in Broadcast signal, will have an almost invisible effect on high definition signals. Similarly a system designed for high definition systems will show poor results with Broadcast signals. This system can be tailored and optimized for any television standard. Tailoring is achieved by changing the clock frequency, increasing or decreasing the number of latches, changing the points where buses 32 and 33 are connected to the latches etc. Increasing the clock frequency reduces the delay between the latch stages. Increasing the number of latch elements lengthens the delay. For instance, if as shown in FIG. 1, bus 32 is connected to the output of Latch 4 instead of Latch 5, there will be a bigger delay between the two signals going into the subtracting element 28, which means that slower rise times at the input 1, will cause greater amplitude signals at the subtracting element 28 and thus permit system to operate well with lower bandwidth television signals. Adding and subtracting delay latches also permits the designer to place signal in better locations. For instance, optimum placement of waveform 506 by shifting it a little to the right or left will produce the best rise time to overshoot ratio in waveform 505.

Increasing the clock frequency will reduce all the delays, making the system appropriate for higher bandwidth television signals.

As is evident from FIG. 5, the overshoot is partly dependent on the timing of the signals relative to one another. This system has a considerable leeway for shifting signals by adding or subtracting latches, changing the frequency of the clock or moving bus taps. If, for instance, as mentioned above, bus 32 were tapped at the output of Latch 4 instead of Latch 5, the system would be optimized for slower rise times, since the time difference between the two signals going into the Subtracting element 28 would be greater and therefore the difference would be a larger number.

The purpose of latches 5 and 6 and the subtracting element 28 is one embodiment of a method for obtaining a signal which is proportional to the change in amplitude of the incoming signal. The use of any other method for detecting changes in amplitude would not circumvent the basic concepts or spirit of this invention.

Obviously, numerous modifications and variations of the present invention are possible in light of the above teachings. For example, though this system is described for a digital application, the principles can be applied to analog or software applications. The analog system will of course not require the analog to digital or digital to analog converter. It is therefore understood that within the scope of the appended claims, the invention may be practiced otherwise than as specifically described herein.

What is claimed is:

1. A video enhancement component for enhancing a video signal, which comprises:
(a.) a slope detector means for generating a slope detected signal, the amplitude of which is dependent on the change in amplitude of an input video signal;
(b.) means for setting a first threshold level, being a high threshold level, for said slope detected signal;
(c.) means for setting a second threshold level, being a low threshold level, for said slope detected signal;
(d.) threshold change switching means connected to said first and said second threshold setting means;
(e.) slope comparator means for comparing said slope detected signal with said threshold change switching means;
(f.) slope change switching means to switch between said slope detected signal and a lower level signal to generate a second signal; and,
(g.) means for combining said second signal from the slope change switching means with said input video signal.

2. The component of claim 1 wherein said slope detector means includes means to generate both positive slope detected signals and negative slope detected signals, and said component further includes a first subsystem for positive slope detected signals, which includes:
(b.-p.) means for setting a first threshold level of said positive slope detected signal;
(c.-p.) means for setting a second lower threshold level of positive said slope detected signal;
(d.-p.) threshold change switching means connected to said first and said second threshold setting means;
(e.-p.) positive slope comparator means for comparing said positive slope detected signal with said threshold change switch means;
(f.-p.) slope change switching means to switch between said positive slope detected signal and a lower level signal to generate a second signal; and,
(g.-p.) means for combining said second signal from the slope change switching means with said input video signal; and,
said component further includes a second subsystem for negative slope detected signals, which includes:
(b.-n.) means for setting a first threshold level of said negative slope detected signal;
(c.-n.) means for setting a second threshold level of said negative slope detected signal;
(d.-n.) threshold change switching means connected to said first and said second threshold setting means;
(e.-n.) negative slope comparator means for comparing said negative slope detected signal with said threshold change switch means;
(f.-n.) slope change switching means to switch between said negative slope detected signal and a less negative level signal to generate a second signal; and,
(g.-n.) means for combining said second signal from the slope change switching means with said input video signal.

3. The component of claim 1, which further includes an analog to digital converter upstream from said slope detector means.

4. The component of claim 1, which further includes a digital to analog converter downstream from said means for combining said second signal with said input video signal.

5. The component of claim 1, which further includes a low pass filter interposed between said second signal and said means for combining said second signal with said input video signal.

6. The component of claim 1, which includes a means for amplifying output of said slope detector means.

7. The component of claim 1, where said slope detector means includes a subtracting element means, a means for delaying an original input video signal to create a delayed input video signal, connecting means for inserting said original input video signal into a first input of said subtracting element means, and connecting means for inserting said delayed input video signal into a second input of said subtracting means.

8. The component of claim 1 wherein said slope detector means includes means for creating a plurality of separately delayed input video signals, and subtracting means connected to two of said plurality of delayed input video signals to generate said slope detected signal and wherein said means for combining said second signal with said input video signal combines said second signal with one of said plurality of delayed input video signals.

9. The component of claim 8 which includes an analog to digital converter upstream from said slope detector means, and includes a digital to analog converter downstream from said means for combining said second signal with said input video signal.

10. The component of claim 8 which includes a gain controlling means interposed between said slope detector means and said means for combining said second signal and said input video signals.

11. The component of claim 8 which includes a low pass filter interposed between said second signal and said means for combining said second signal with one of said delayed input video signals.

12. A video enhancement component for enhancing a video signal, which comprises:
(a.) a slope detector means for generating a slope detected signal from an original input video signal;
(b.) means for setting a first threshold level, being a high threshold level, for said slope detected signal;
(c.) means for setting a second lower threshold level, being a low threshold level, for said slope detected signal;
(d.) threshold change switching means connected to said first and said second threshold setting means;
(e.) slope comparator means for comparing said slope detected signal with said threshold change switching means to create a first activated output;
(f.) means for combining said slope detected signal with the original input video signal to form a combined video signal;
(g.) overshoot comparator means for comparing the combined second video signal and said original input video signal to create a second activated output;
(h.) output control switch means for switching between said combined video signal and said original input video signal, and;
(i.) controlling means to activate said output control switch means only when said slope comparator and said overshoot comparator generate said first activated output and said second activated output.

13. The component of claim 12 wherein said component includes: means for operating separately on positive slope detected signals and negative slope detected signals by using elements (b) through (i) above for positive slope detected signals, and including duplicate elements (b) through (ii) above for use with negative slope detected signals.

14. The component of claim 12 which includes an analog to digital converter upstream from said slope detector means, and includes a digital to analog converter downstream from said controlling means.

15. The component of claim 12 which includes a low pass filter interposed between said slope detected signal and the means for combining said slope detected signal to said original input video signal.

16. The component of claim 12 which includes a means for amplifying the output of said slope detected signal.

17. The component of claim 12 which includes subtracting means connected to two of said plurality of delayed input video signals to generate said slope detected signal, and wherein said second comparator means is adapted for comparing said combined second video signal with one of the less delayed video input signals to form said second activated output.

18. A component of enhancing a video signal comprising:
a delay means for creating a delayed video signal, a slope detector means for generating a slope detected signal from the delayed video signal, means for setting a first threshold level, means for setting a second lower threshold level, first switching means connected to first and second threshold setting means, slope comparator means for comparing the slope detected signal with the first switch means to create an activated output, second switching means to switch between said slope detected signal and a constant low level signal, means for combining the signal from the second switching means with the originating video signal to form a combined video signal, overshoot comparator means for comparing the combined video signal and the undelayed video signal to create an activated output, third switch means for switching between the combined video signal and the undelayed video signal and controlling means to activate the third switch means only when first and second comparators are activated.

19. The component of claim 18 which includes an analog to digital converter upstream from said slope detector means, and includes a digital to analog converter downstream from said means for combining said second signal with said input video signal.

20. The component of claim 18 which includes a low pass filter interposed between said signal and said means for combining said second signal with said input video signal.
